(19) United States
(12) Patent Application Publication
(10) Pub. No.: US 2015/0273794 A1
(43) Pub. Date: Oct. 1, 2015

(54) PREPREG ELEMENT WITH IMPROVED STRUCTURE

(71) Applicant: TYKO TECH. CO., LTD., New Taipei City (TW)

(72) Inventors: CHIH-HSIAO CHIEN, New Taipei City (TW); YI-HUNG LIN, New Taipei City (TW)

(21) Appl. No.: 14/594,121

(22) Filed: Jan. 10, 2015

(30) Foreign Application Priority Data
Mar. 26, 2014 (TW) 103205210

(51) Int. Cl. B32B 5/26

(52) U.S. Cl. CPC B32B 5/26; B32B 2250/20; B32B 2255/02; B32B 2255/26; B32B 2307/54

(57) ABSTRACT

A prepreg element with improved structure comprises at least two layers of filament sheet that are stacked on top of each other, wherein each layer of filament sheet is filled with materials having a linear pattern in a unitary orientation in horizontal plane, and is further coated with resin on its surface; when stacked up, two layers of filament sheet that are adjacent to each other have the linear patterns in different orientations; the at least two layers of filament sheet with different orientations is subsequently processed through coating, yarn expanding and laminating to provide tensile strength in multiple orientations in horizontal plane, and increase the overall structural strength with no extra thickness being added to the material, nor is added to overall appearance of the prepreg element, so as to achieve the improvement of structural strength and toughness without adding extra thickness.

### BACKGROUND OF THE INVENTION

1. Field of the Invention

The present invention relates to a prepreg element with improved structure, and more particularly to a prepreg element comprising at least two layers of filament sheet respectively having linear patterns with multiple orientations to provide tensile strength in different orientations in horizontal plane, and increase the overall structural strength and tensile modulus.

2. Related Art

With the advance of technology, the raw material product applied in food, clothing, shelter, transportation, entertainment and the like, has been upgraded for achieving better product quality and longer product life. In recent years, the raw material, such as fiber, has been found numerous applications in aerospace and transportation fields. Fiber with features like lightness in weight, thinness in thickness, toughness in structure, energy conservation, and has been popular to manufacturing industry, also has been used in large quantities. In particular, carbon fiber and glass fiber are usually processed in accordance with the unidirectional orientation of their linear patterns to produce unidirectional prepreg elements as the raw material products. The unidirectional prepreg element with lightness, thinness and toughness is then adjusted to be 20 g/m² or 70 g/m² in density to provide a wider range of applications, such as airplanes, vehicles, bikes, 3C product shells, golf clubs, hocky sticks, badminton racket frames and tennis racket frames.

Referring to FIG. 4 and FIG. 5, in convention, fiber filaments A1 filled in a unidirectional prepreg element A are stacked up in accordance with the unidirectional orientation of their linear patterns for the required thickness of the unidirectional prepreg element A; and then the unidirectional prepreg element A that has been thickened is glued with resin A2 on the surface thereof To achieve the required structural strength, larger amounts of the fiber filaments A1 need to be used to thicken the unidirectional prepreg element A, which incurs higher manufacturing costs. Besides, as the toughness has been increased, the unidirectional prepreg element A has become so thicker that it is difficult to be processed as desired shape, thus causing high difficulty, low efficiency, time consuming in subsequent processing and high expenditures as well. In addition, the unidirectional prepreg element A is quite limited in improving its structural strength by means of stacking up the fiber filaments A1 because the orientation of the linear patterns of the fiber filaments A1 is unidirectional, namely, the unidirectional prepreg element A does not perform well on tensile strength and tensile modulus in multiple directions in horizontal plane where it is located. In this situation, the unidirectional prepreg element A keeps being expanded in its thickness by filling up with a large amount of fiber filaments A1 for improving just a little structural strength, therefore causing the consumption of large quantity of the fiber filaments A1 and the rise in manufacturing costs. If the unidirectional prepreg element A can be prepared with thinner thickness for facilitating subsequent processing, the unidirectional prepreg element A would become so weak that it could not be manufactured as the product that requires higher structural strength and toughness. Thus, for the related manufacturing process operators, it turns out to be a challenging choice of balance between the manufacturing costs and the required structural strength, and the choice is always not easy to be made during processing.

It is believed that problems like how to successfully make a desired shape when a unidirectional prepreg element gets thicker for required structural strength, and how to efficiently improve structural strength of a prepreg element with the unidirectional orientation, are the goals that need to be achieved.

### SUMMARY OF THE INVENTION

Accordingly, an object of the present invention is to prepare a prepreg element with improved structure capable of improving structural strength and toughness by increasing the tensile strength and the tensile modulus in multiple directions in horizontal plane.

To attain this, the prepreg element with improved structure comprises at least two layers of filament sheet that are stacked on top of each other, wherein each layer of filament sheet is filled with materials having a linear pattern in a unitary orientation in horizontal plane, and is further coated with resin on its surface; when stacked up, two layers of filament sheet that are adjacent to each other have the linear patterns in different orientations; subsequently, the prepreg element comprising at least two layers of filament sheet with different orientations needs to be processed through coating, yarn expanding and laminating to provide tensile strength in different orientations in horizontal plane, and increase the overall structural strength; when the prepreg element is manufactured as per a certain regular dimension, there is no extra thickness being added to the material, nor is added to overall appearance of the prepreg element, so as to achieve the improvement of structural strength and toughness; and therefore, the prepreg element produces the improvement in structural strength and toughness without adding extra thickness.

In accordance with the present invention, the orientations of the linear patterns are represented at angles in horizontal plane ranged from 0° to ±180° which are adjusted in accordance with manufacturing needs by rotating either clockwise or counter-clockwise in horizontal plane.

### BRIEF DESCRIPTION OF THE DRAWINGS

FIG. 1 is a perspective view of prepreg element with improved structure of the present invention;

FIG. 2 is an exploded perspective view of prepreg element with improved structure of the present invention;

FIG. 3 is a cross-sectional view of prepreg element with improved structure of the present invention;

FIG. 4 is a perspective view of conventional prepreg element;

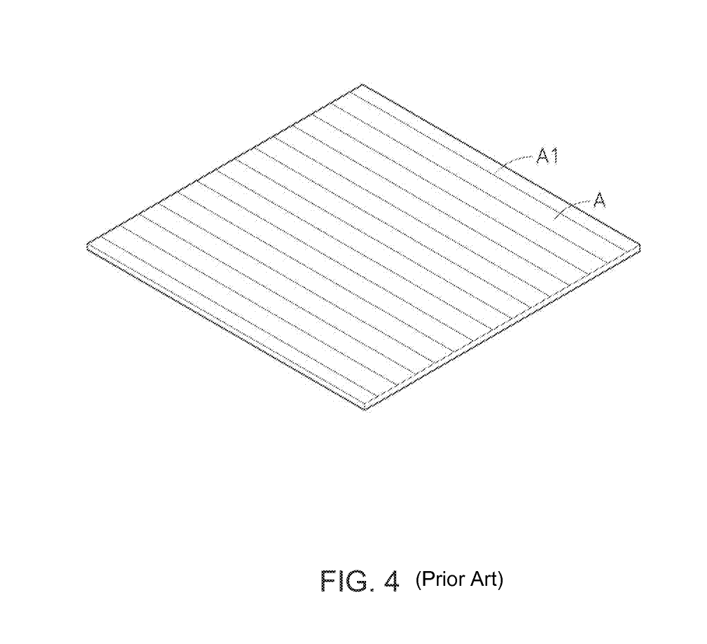

FIG. 5 is a cross-sectional view of conventional prepreg element.

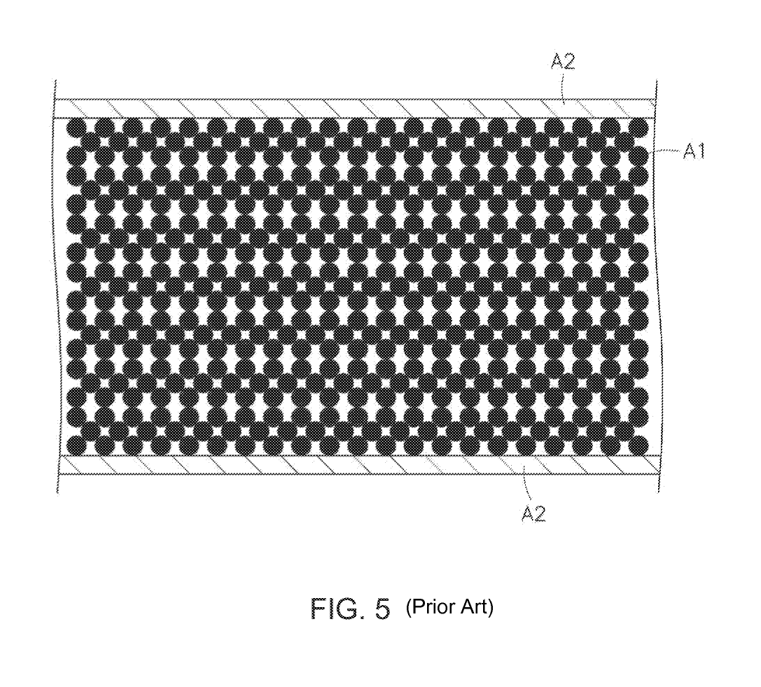

### DESCRIPTION OF THE PREFERRED EMBODIMENTS

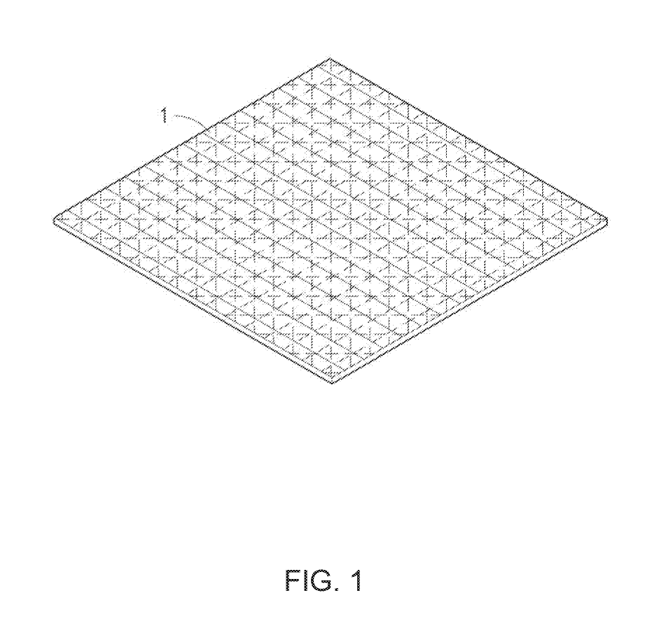

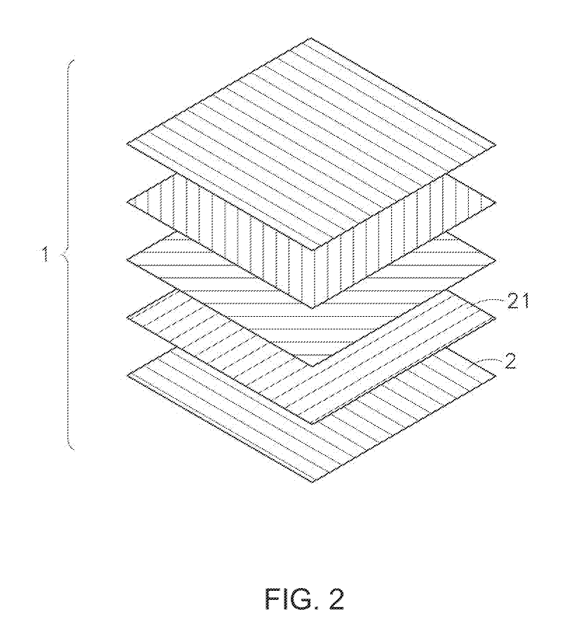

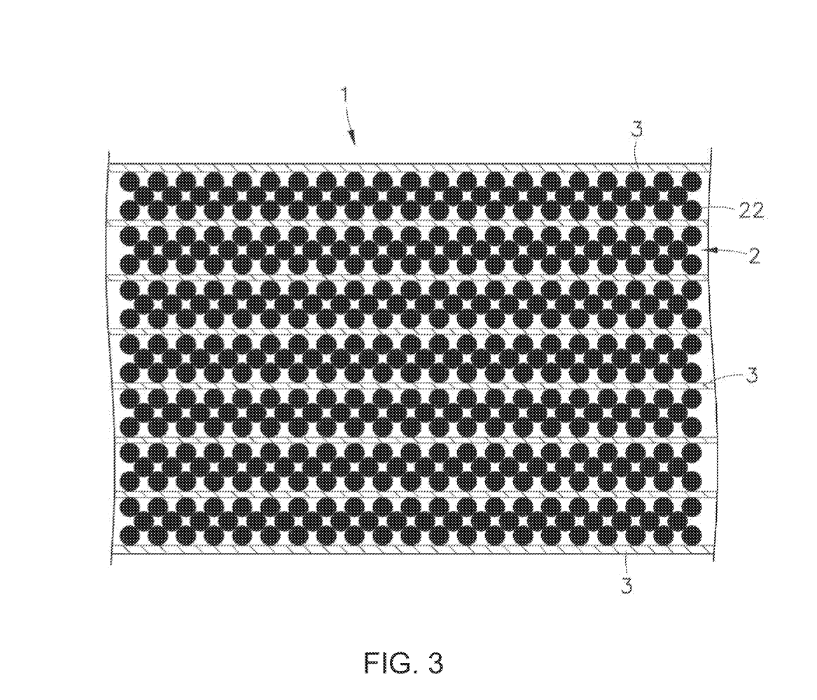

Referring to FIGS. 1 to 3, a prepreg element 1 of the present invention comprises at least two layers of filament sheet 2 that are stacked on top of each other, wherein each layer of filament sheet 2, is filled with materials 22 having a linear pattern 21 in a unitary orientation in horizontal plane, e.g., longitudinal, latitudinal or oblique orientations, and is further coated with resin 3 on its surface, e.g., thermoset or thermoplastic resin. When stacked up, two layers of filament sheet 2 that are adjacent to each other have the linear patterns 21 in different orientations, wherein the material 22 can be chosen from carbon fiber, glass fiber, scrim and resin, and the materials 22 of two different layers of filament sheet 2 can be of same or different. Subsequently, the at least two layers of filament sheet 2 with different orientations needs to be processed through coating, yarn expanding and laminating to provide tensile strength in different orientations in horizontal plane, and increase the overall structural strength. Accordingly, the tensile strength and the tensile modulus of the prepreg element 1 are thus improved in this manner. When the prepreg element 1 is manufactured as per a certain regular dimension, there is no extra thickness being added to the material 22, nor is added to overall appearance of the prepreg element 1, so as to achieve the improvement of structural strength and toughness. In other words, the prepreg element 1 of the present invention produces the improvement in structural strength and toughness without adding extra thickness.

As above, each layer of filament sheet 2 is characterized in its linear pattern 21 having a unitary orientation which is different from orientation(s) of other layer(s) of filament sheet. The orientations of the linear patterns 21 within the at least two layers of filament sheet 2 could be at angles in horizontal plane ranged from 0° to ±180° adjusted in accordance with manufacturing needs by rotating either clockwise or counter-clockwise in horizontal plane, e.g., 0°, 45°, −45°, −60°, 90°, 120°; however, it is believed that the described angles such as 0°, 45°, −45°, −60°, 90°, 120° are just the best models, and any other angles of the orientation in the range 0° to ±180° are within the scope of the present invention.

As above, when two adjacent layers of filament sheets having different orientations of the linear patterns 21 are stacked up, the at least two layers of filament sheet 2 provides the toughness and tensile strength in multiple directions in horizontal plane, so that the prepreg element 1 produces good performance in strength and toughness without extra weight and thickness for prolonging its usage lifespan.

The prepreg element 1 with improved structure makes a technological breakthrough by solving the problem resulted from unsatisfactory structural strength and tensile strength caused by the conventional prepreg element with unidirectional orientation. Further, compared to the conventional prepreg element, the prepreg element 1 of the present invention is made with the same thickness and the same amount of materials so that the prepreg element 1 of the present invention achieves much better performance in the tensile strength and the tensile modulus, which also facilitating the subsequent processing and easier molding of products.

In applications, the prepreg element 1 of the present invention can be utilized to manufacture high-strength and high-toughness products, such as airplanes, vehicles, bikes, 3C product shells, or golf clubs, hocky stick, badminton racket frames, tennis racket frames, which show better performance in solidness than conventional prepreg element with only unidirectional orientation.

It is understood that the invention may be embodied in other forms within the scope of the claims. Thus the present examples and embodiments are to be considered in all respects as illustrative, and not restrictive, of the invention defined by the claims.

What is claimed is:

1. A prepreg element with improved structure, comprising at least two layers of filament sheet that are stacked on top of each other, wherein each layer of the at least two layers of filament sheet is filled with materials arranged in a linear pattern having a unitary orientation in horizontal plane and is further coated with resin on its surface, and any two adjacent layers of the at least two layers of filament sheet have the linear patterns with the different orientations.

2. The prepreg element with improved structure of claim 1, wherein the materials are chosen from carbon fiber, glass fiber, scrim, and resin.

3. The prepreg element with improved structure of claim 1, wherein the materials of different layers of filament sheet are same or different.

4. The prepreg element with improved structure of claim 1, wherein the orientations of the linear patterns are represented at angles in horizontal plane ranged from 0° to ±180° which are adjusted in accordance with manufacturing needs by rotating either clockwise or counter-clockwise in horizontal plane; furthermore, the at least two layers of filament sheet having the linear patterns with the different orientations is subsequently processed through coating, yarn expanding and laminating to provide tensile strength in multiple orientations in horizontal plane, as well as to increase the overall structural strength.
